(19) United States
(12) Patent Application Publication
(10) Pub. No.: US 2006/0015647 A1
(43) Pub. Date: Jan. 19, 2006

(54) System and method for communication between heterogeneous networks

(75) Inventors: Seong-min Kang, Seoul (KR); Jae-hwang Lee, Seoul (KR); Sun-woo Kim, Suwon-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 11/181,794

(22) Filed: Jul. 15, 2005

(30) Foreign Application Priority Data
Jul. 16, 2004 (KR) 2004-55479

(51) Int. Cl. G06F 15/16

(52) U.S. Cl. 709/245

(57) ABSTRACT

There are provided communication systems and methods over a network. The communication method includes updating a mapping table so as to map a first address available in a network where a client is located and a second address available in a network where a server is located, and relaying communication according to a protocol managing sessions between the client and the server on the basis of the updated mapping table. As the proxy server shares address conversion and protocol conversion functions with the NAT-PT, it is possible to reduce the loads of the NAT-PT.

### CROSS-REFERENCE TO RELATED APPLICATION

This application claims the benefit of Korean Patent Application No. 10-2004-0055479, filed on Jul. 16, 2004, in the Korean Intellectual Property Office, the disclosure of which is incorporated herein in its entirety by reference.

### BACKGROUND OF THE INVENTION

1. Field of the Invention

The present invention relates generally to a communication system and method over a network. More particularly, embodiments of the present invention relate to a system and method for communication between heterogeneous networks.

2. Description of the Related Art

In order to overcome the limited Internet address availability in an existing IPv4 (Internet Protocol version 4) environment, IPv6 (Internet Protocol version 6) has been proposed, which is capable of providing expanded address availability. However, converting existing IPv4 applications to IPv6 applications in a short period of time is nearly impossible. Conversion to the IPv6 environment has been gradually progressing and at present, IPv4 and IPv6 environments coexist. To remove communication disturbances due to the coexistence of the IPv4 and IPv6 environments, a NAP-PT (Network Address Translater-Protocol Translater) has been developed. The NAP-PT is generally located in a boundary router of an IPv6 network and an IPv4 network to convert IPv6 packets to IPv4 packets and vice versa. Such a NAP-PT is described in detail in RFC (Request for Comments) 2766 and RFC 2765, available from the Internet Engineering Task Force.

FIG. 1 is a schematic representation a SIP (Session Initiation Protocol) signaling process through a conventional communication system. Referring to FIG. 1, the conventional communication system comprises a UAC (User Agent Client) 1, a proxy server 2, a location server 3, a NAP-PT 4, and a UAS (User Agent Server) 5.

The UAC 1 is located in the IPv6 network and transmits an IPv6 invitation message for starting SIP signaling. The SIP, which is a simple text-based application-layer protocol, is used to manage sessions between the UAC 1 and UAS 5. That is, the SIP is a protocol regarding a procedure of creating, correcting and terminating sessions. Users communicating with each other according to the SIP use a URI (Uniform Resource Identifier) having a similar format with an E-mail address, e.g., “user@host-plus-domain”, as an identifier for the other party.

If the proxy server 2 located between the UAC 1 and UAS 5 receives an invitation message from the UAC 1, the proxy server 2 transmits a URI included in the received invitation message to a location server 3 to request the location of the UAS 5. If the location server 3 receives the request for the location of the UAS 5, the location server 3 transmits the location of the UAS 5, that is, an IPv4 address of the UAS 5, to the proxy server 2, in response to the request.

If the proxy server 2 receives the IPv4 address of the UAS 5 from the location server 3, the proxy server 2 recognizes a fact that the UAS 5 is located in the IPv4 network. At this time, the proxy server 2 requests an address conversion and a protocol conversion from the NAP-PT 4 to convert the IPv6 invitation message received from the UAC 1 to an IPv4 invitation message. If the NAP-PT 4 receives the request for address conversion and protocol conversion from the proxy server 2, the NAP-PT 4 allocates an IPv4 address among IPv4 addresses stored in an address pool to the UAC 1 with an IPv6 address. Also, the NAP-PT 4 converts the IPv6 invitation message received from the UAC 1 to an IPv4 invitation message including the IPv4 address of the UAC 1 and the IPv4 address of the UAS 5. Also, the NAT-PT 4 transmits the IPv4 invitation message to the proxy server 2 in response to the request.

The proxy server 2 transmits the IPv4 invitation message converted by the NAT-PT 4 to the UAS 5. If the UAS 5 receives the IPv4 invitation message from the proxy server 2, a telephone embedded in the UAS 5 rings, so that the user recognizes a call. Then, the UAS 10 transmits a 200 OK message with an IPv4 format for allowing communication with the UAC 1 to the proxy server 2, according to the user's command.

The proxy server 2 transmits a 200 OK message with an IPv6 format converted by the NAT-PT 4 to the UAC 1, by performing the procedure as described above. If the UAC 1 receives the 200 OK message with the IPv6 format from the proxy server 2, the UAC 1 transmits a message indicating that the 200 OK message is normally received, as an ACK (acknowledge) message of an IPv6 format, to the proxy server 2.

The proxy server 2 transmits an ACK message with an IPv4 format converted by the NAP-PT 4 to the UAS 5, by performing the procedure as described above. When the UAS 5 receives the ACK message with the IPv4 format from the proxy server 2, the SIP signaling process is completed and a session between the UAC 1 and UAS 5 is created.

FIG. 2 is a schematic representation of a RTP (Real-time Transport Protocol) communication process through a conventional communication system. Referring to FIG. 2, a UAC 1 transmits an IPv6 packet to start RTP communication with a UAS 5. The RTP is a transmission layer protocol for transmitting or receiving real-time data such as video and audio.

If the proxy server 2 receives an IPv6 packet from the UAC 1, the proxy server 2 requests conversion of the IPv6 packet to an IPv4 packet from a NAT-PT 4. If the NAT-PT 4 receives the request from the proxy server 2, the NAT-PT 4 converts the IPv6 packet to an IPv4 packet and transmits the converted IPv4 packet to the proxy server 2 in response to the request.

If the proxy server 2 receives an IP4 packet from the NAP-PT 4, the proxy server 2 transmits the IPv4 packet to the UAS 5. The UAS 5 receives the IPv4 packet from the proxy server 2. The UAS 5 transmits another IPv4 packet to the proxy server 2 for RTP communication with the UAS 1.

If the proxy server 2 receives the IPv4 packet from the UAS 5, the proxy server 2 requests conversion of the IPv4 packet to an IPv6 packet to the NAT-PT 4. If the NAT-PT 4 receives the request from the proxy server 2, the NAT-PT 4 converts the IPv4 packet to an IPv6 packet and transmits the converted IPv6 packet to the proxy server 2 in response to the request.

If the proxy server 2 receives the IPv6 packet from the NAT-PT 4, the proxy server 2 transmits the IPv6 packet to the UAC 1. The UAC 1 receives the IPv6 packet from the proxy server 2.

FIG. 3 is a schematic representation of the NAT-PT shown in FIGS. 1 and 2. Referring to FIG. 3, a NAT-PT 4 receives an IPv6 packet with a source address 3FFE:2E01::1 and a destination address 3FFE:2E01:2A:4:123.456.78.90 from the proxy server 2. At this time, the proxy server 2 corresponds to an IPv6 node.

The NAT-PT 4 allocates an address 111.222.10.20 among IPv4 addresses stored in an address pool to the source address 3FFE:2E01::1 to convert the IPv6 packet to an IPv4 packet, and removes a network prefix 3FFE:2E01:2A:4::/96 of the IPv6 network where the UAC 1 is located, from the destination address 3FFE:2E01:2A:4:123.456.78.90, thereby extracting a destination address 123.456.78.90 with an IPv4 format. At this time, the NAT-PT 4 adds a mapping entry for mapping the source address 3FFE:2E01::1 with the IPv6 format and the source address 111.222.10.20 with the IPv4 format, to a mapping table, for later communication.

The NAT-PT 4 transmits an IPv4 packet including the source address 111.222.10.20 with the IPv4 format and the destination address 123.456.78.90 with the IPv4 format to the proxy server 2.

If the proxy server 2 receives the IPv4 packet transmitted from the NAT-PT 4, the proxy server 2 transmits the IPv4 packet to the UAS 5. Here, the proxy server 2 corresponds an IPv4 node. The proxy server 2 has a dual stack including an IPv6 protocol stack and an IPv4 protocol stack to relay communication between clients located in the IPv6 network and a server located in the IPv4 network.

However, the NAT-PT 4 is an apparatus for performing address conversion and protocol conversion in an IP layer and does not support the SIP. To allow the NAT-PT 4 to perform SIP signaling, a separate SIP-ALG (Application Level Gateway) should be installed in the NAT-PT 4. Here, the SIP-ALG refers to application software allowing SIP signaling.

Accordingly, the NAT-PT 4 should reach an application layer to perform packet conversion according to the SIP signaling process, which gives excessive load to the NAT-PT 4 performing frequent address conversion and protocol conversion. Since a general NAT-PT processes packets in the IP layer level, it is unnecessary to process the upper layers of the IP layer, however, since the NAT-PT having the SIP-ALG processes even application layers, address conversion and protocol conversion by the NAT-PT are delayed.

Due to such delay of address conversion and protocol conversion, the speed of SIP signaling and RTP communication is reduced. Also, since the NAT-PT is a kind of router, the performance of packet routing is reduced all over the network.

### SUMMARY OF THE INVENTION

An aspect of the present invention provides an apparatus and method capable of enhancing the speed of SIP signaling and RTP communication and improving the performance of packet routing over a network by removing delays of address conversion and protocol conversion in a NAT-PT.

An aspect of the present invention also provides a computer readable recording medium having embodied thereon a computer program for executing the method on a computer.

According to an aspect of the present invention, there is provided a communication relay method comprising (a) updating a mapping table so as to map a first address available in a network where a client is located and a second address available in a network where a server is located, and (b) relaying communication according to a protocol managing sessions between the client and the server on the basis of the updated mapping table.

According to another aspect of the present invention, there is provided a proxy server comprising a mapping table update unit updating a mapping table to map a first address available in a network where a client is located and a second address available in a network where a server is located, and a communication relay unit relaying communication according to a protocol managing sessions between the client and the server on the basis of the mapping table updated by the mapping table update unit.

According to another aspect of the present invention, there is provided a computer storage for controlling a computer according to a method, the method comprising updating a mapping table to map a first address available in a network where a client is located and a second address available in a network where a server is located, and relaying communication according to a protocol managing sessions between the client and the server on the basis of the updated mapping table.

According to another aspect of the present invention, there is provided a communication method comprising (a) providing an address available in a network where a server is located, and (b) relaying communication according to a protocol managing sessions between a client and the server using an address available in a network where the client is located and the provided address available in the network where the server is located.

According to another aspect of the present invention, there is provided a communication system comprising a router providing an address available in a network where a server is located, and a proxy server relaying communication according to a protocol managing sessions between a client and the server using an address available in a network where the client is located and the address provided by the router.

According to another aspect of the present invention, there is provided a computer storage for controlling a computer according to a method comprising providing an address available in a network where a server is located, and relaying communication according to a protocol managing sessions between a client and the server using an address available in a network where the client is located and the provided address available in the network where the server is located.

According to another aspect of the present invention, there is provided a computer readable recording medium having embodied thereon a computer program for executing the communication method on a computer.

Additional aspects and/or advantages of the invention will be set forth in part in the description which follows and, in part, will be apparent from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a schematic representation of a SIP (Session Initiation Protocol) signaling process through a conventional communication system;

FIG. 2 is a schematic representation of a RTP (Real-time Transport Protocol) communication process through a conventional communication system;

FIG. 3 is a schematic representation of the NAT-PT (Network Address Translater-Protocol Translater) shown in FIGS. 1 and 2;

FIG. 4 is a schematic representation of a SIP signaling process through a communication system according to an embodiment of the present invention;

FIG. 5 is a schematic representation of a RTP communication process through the communication system shown in FIG. 4;

FIG. 6 is a schematic representation of a detailed configuration of the UAC in the communication system shown in FIGS. 4 and 5;

FIG. 7 is a schematic representation of a detailed configuration of the proxy server in the communication system shown in FIGS. 4 and 5;

FIG. 8 is a schematic representation of a detailed configuration of the location server in the communication system shown in FIGS. 4 and 5;

FIG. 9 is a schematic representation of a detailed configuration of the NAP-PT in the communication system shown in FIGS. 4 and 5;

FIG. 10 is a schematic representation of a detailed configuration of the UAS in the communication system shown in FIGS. 4 and 5; and

FIGS. 11, 12 and 13 are a flowchart illustrating a communication method according to an embodiment of the present invention.

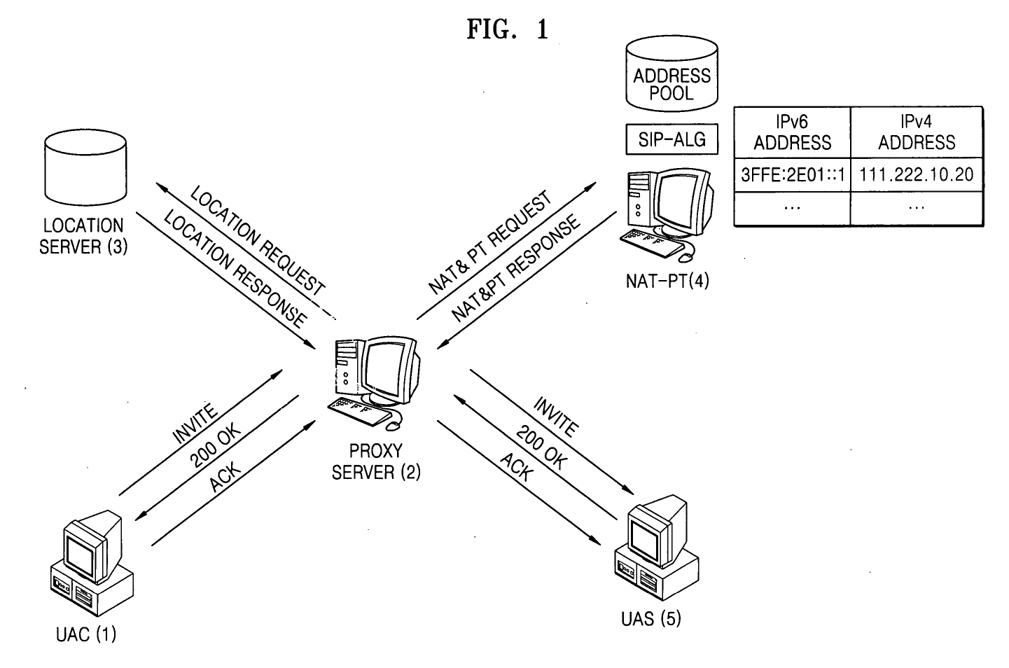

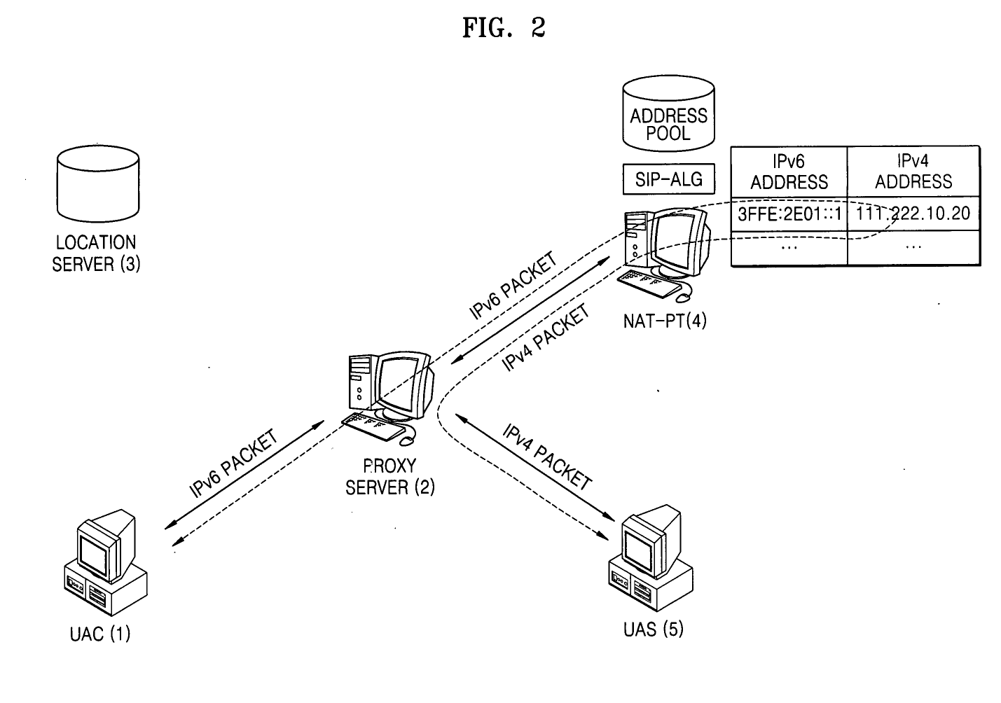

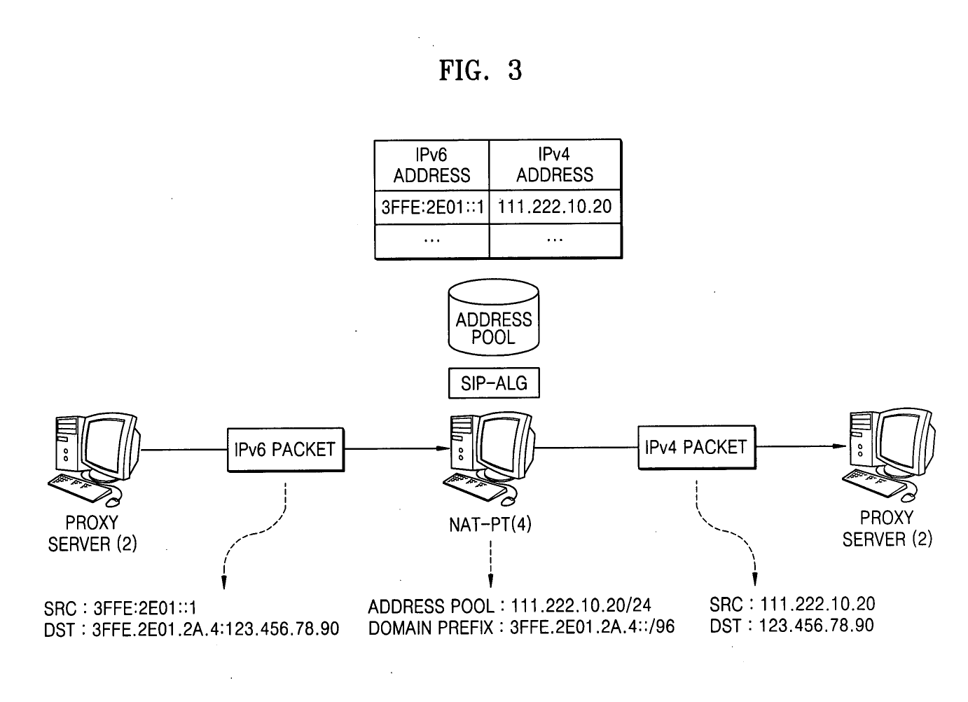

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

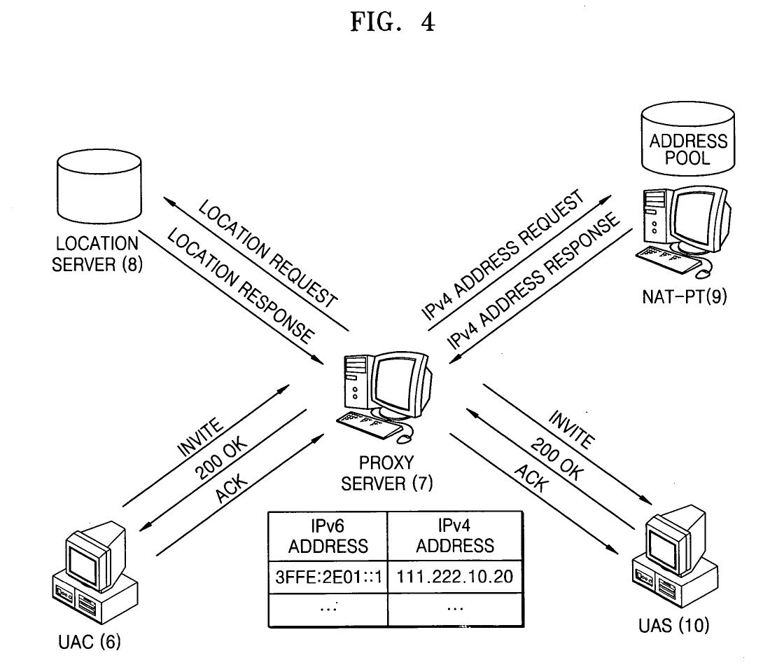

FIG. 4 is a schematic representation of a SIP (Session Initiation Protocol) signaling process in a communication system according to an embodiment of the present invention. Referring to FIG. 4, the communication system comprises a UAC 6 (User Agent Client), a proxy server 7, a location server 8, a NAT-PT 9 (Network Address Translater-Protocol Translater) and a UAS (User Agent Server) 10.

The UAC 6 is located in a IPv6 network, transmits an invitation message to the UAS 10, receives a 200 OK message from the UAS 10, and transmits an ACK message to the UAS 10, according to the SIP. The SIP, which is a simple text-based application-layer control protocol as described above, manages sessions between the UAC 6 and the UAS 10. That is, the SIP is used to create, correct and terminate sessions.

The proxy server 7 is located between the UAC 6 and UAS 10 to relay SIP communication between the UAC 6 and UAS 10 using an IPv6 address available in the IPv6 network where the UAC 6 is located and an IPv4 address provided by the NAT-PT 9. That is, the proxy server 7 converts an IPv6 address available in the IPv6 network where the UAC 6 is located to an IPv6 address available in the IPv4 network where the UAS 10 is located, and converts the IPv4 packet to an IPv6 packet using the converted IPv4 address, to thereby transmit an invitation message, a 200 OK message, and an ACK message in accordance with SIP.

If the location server 8 receives a request for the location of the UAS 10 from the proxy server 7, the location server 8 transmits the location of the UAS 10 to the proxy server 7 in response to the request. In this embodiment, if the location server 8 receives a request for an IP address of the UAS 10 from the proxy server 7, the location server 8 provides an IPv4 address of the UAS 10 to the proxy server 7 in response to the request.

If the NAT-PT 9, which is a kind of router, receives a request for an IPv4 address of the UAC 6 from the proxy server 7, the NAT-PT 9 provides an IPv4 address among IPv4 addresses stored in an address pool to the proxy server 7 in response to the request.

The UAS 10, which is located in the IPv4 network, receives an invitation message from the UAC 6, transmits a 200 OK message to the UAC 6 and receives an ACK message from the UAC 6, in accordance with SIP.

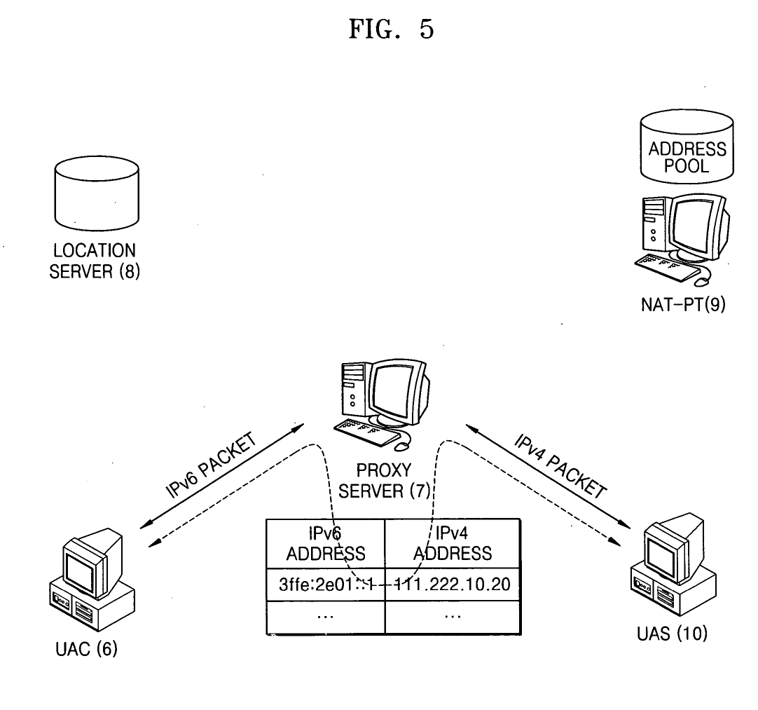

FIG. 5 is a schematic representation of a RTP communication process through the communication system shown in FIG. 4. The UAC 6 transmits and receives an IPv6 packet according to the RTP and the UAS 10 transmits and receives the IPv4 packet according to the RTP. The proxy server 7 converts an IPv6 address included in the IPv6 packet received from the UAC 6 to an IPv4 address available in the IPv4 network where the UAS 10 is located, and converts the IPv6 packet received from the UAC 6 to an IPv4 packet including the IPv4 address, to thereby relay communication between the UAC 6 and UAS 10.

Also, the proxy server 7 converts the IPv4 address included in the IPv4 packet received from the UAS 10 to an IPv6 address available the IPv6 network where the UAC 6 is located, and converts the IPv4 packet received from the UAS 10 to an IPv6 packet including the IPv6 address, to thereby relay communication between the UAC 6 and UAS 10. For example, the proxy server 7 may convert an IPv6 packet including a source address 3FFE:2E01::1 of the IPv6 format to an IPv4 packet including a source address 111.222.10.20 of the IPv4 format.

In this embodiment, the proxy server 7 shares the address conversion and protocol conversion functions with the NAT-PT, thus reducing the loads of the NAT-PT. In particular, since the proxy server 7 is based on the SIP, the proxy sever 7 does not require a separate SIP-ALG (Application Level Gateway). Therefore, it is possible to prevent the speed of SIP signaling and RTP communication from being reduced due to the delays of address conversion and protocol conversion in the conventional NAT-PT, and to avoid network-wide deterioration of packet routing performance.

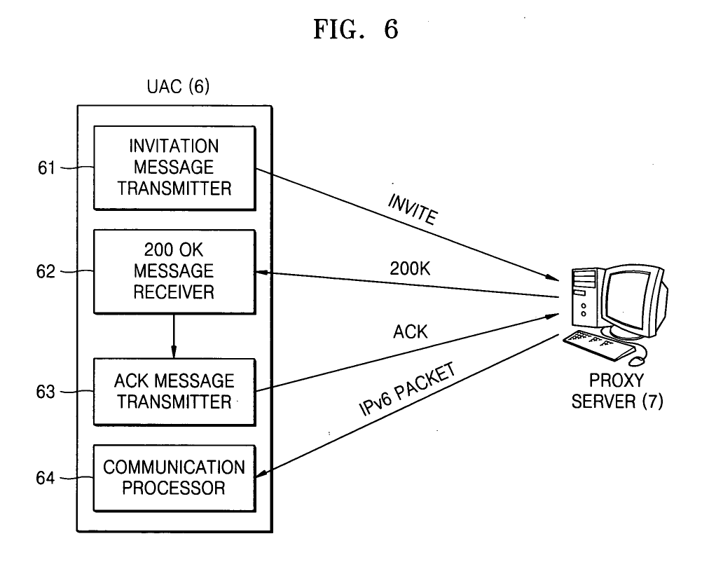

FIG. 6 is a schematic representation of a detailed configuration of the UAC in the communication system shown in FIGS. 4 and 5. Referring to FIG. 6, the UAC 6 comprises an invitation message transmitter 61, a 200 OK message receiver 62, an ACK message transmitter 63, and a communication processor 64.

The invitation message transmitter 61 transmits an invitation message including a URI of the UAS 10 to the proxy server 7 to start SIP signaling. The invitation message transmitted from the invitation message transmitter 61 is a message in the IPv6 format. For example, a source address of the invitation message may be 3FFE:2E01::1 and a destination address thereof may be the URI.

The 200 OK message receiver 62 receives a 200 OK message (for the invitation message transmitted from the invitation message transmitter 61) from the proxy server 2. The 200 OK message input to the 200 OK message receiver 62 is a message in the IPv6 format. For example, a source address of the 200 OK message may be 3FFE:2E01:2A:4:123.456.78.90 and a destination address thereof may be 3FFE:2E01::1.

The ACK message transmitter 63 transmits an ACK message for the 200 OK message input to the 200 OK message receiver 62 to the proxy server 7. The ACK message is a message in the IPv6 format. For example, a source address of the ACK message may be 3FFE:2E01::1 and a destination address thereof may be 3FFE:2E01:2A:4:123.456.78.90.

The communication processor 64 performs RTP communication with a UAS 10 that received the ACK message transmitted from the ACK message transmitter 63 via the proxy server 7. The packet transmitted from the communication processor 64 is an IPv6 packet. For example, a source address of the packet transmitted from the communication processor 64 may be 3FFE:2E01::1 and a destination address thereof may be 3FFE:2E01:2A:4:123.456.78.90, and a source address of the packet input to the communication processor 64 may be 3FFE:2E01:2A:4:123.456.78.90 and a destination address thereof may be 3FFE:2E01::1.

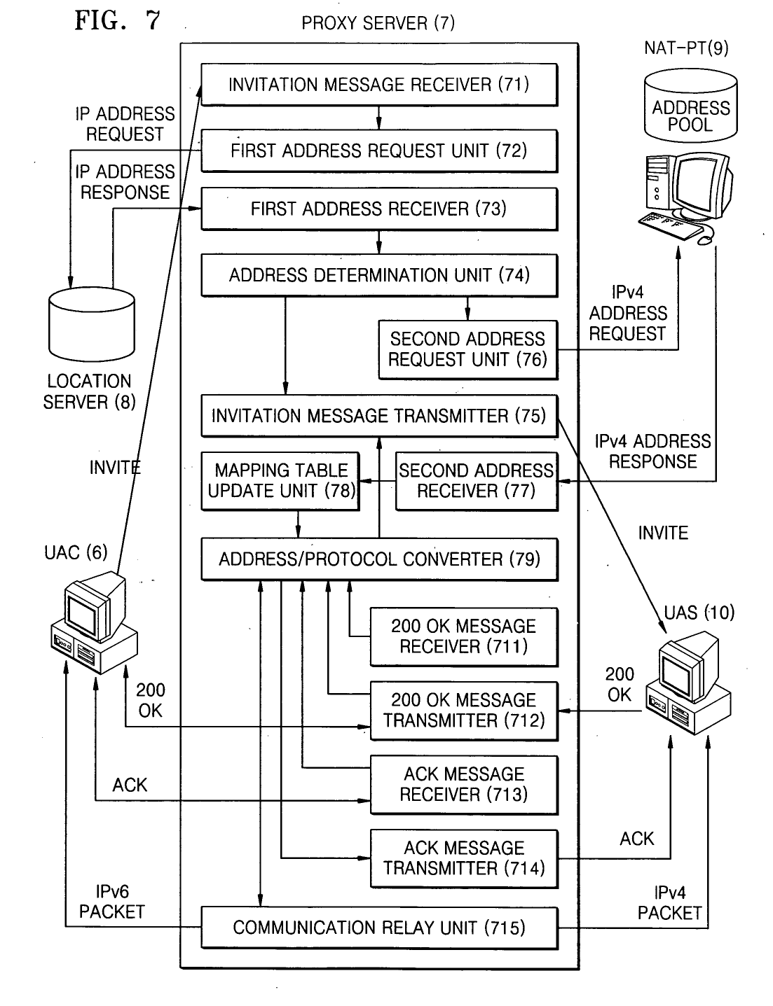

FIG. 7 is a schematic representation of a detailed configuration of the proxy server in the communication system shown in FIGS. 4 and 5. Referring to FIG. 7, the proxy server 7 of the communication system shown in FIGS. 4 and 5 comprises an invitation message receiver 71, a first address request unit 72, a first address receiver 73, an address determination unit 74, an invitation message transmitter 75, a second address request unit 76, a second address receiver 77, a mapping table update unit 78, an address/protocol converter 79, a 200 OK message receiver 711, a 200 OK message transmitter 712, an ACK message receiver 713, an ACK message transmitter 714, and a communication relay unit 715.

The invitation message receiver 71 receives an invitation message from the UAC 6. The invitation message input to the invitation message receiver 71 is a message in the IPv6 format. For example, a source address of the invitation message may be 3FFE:2E01::1 and a destination address thereof is a URI.

The first address request unit 72 requests, from the location server 8, an IP address of a UAS 10 corresponding to a URI included in the invitation message input to the invitation message receiver 71. The first address receiver 73 receives an IP address of the UAS 10 from the location server 8, as a response to the request from the first address request unit 72. For example, the IP address of the UAS 10 is 123.456.78.90 and is in the IPv4 format.

The address determination unit 74 determines whether or not the IP address input to the first address receiver 73 is available in the IPv6 network where the UAC 6 is located. In the above example, since the IP address of the UAS 10 is in the IPv4 format, the IP address cannot be used in the IPv6 network where the UAC 6 is located.

If the address determination unit 74 determines that the IP address received by the first address receiver 73 is available in the IPv6 network where the UAC 6 is located, that is, that the IP address input to the first address receiver 73 is an IPv6 address, the invitation message transmitter 75 transfers an invitation message whose destination address is the IPv6 address to the UAS 10. In this case, the invitation message indicates that the network where the UAS 10 is located is the IPv6 network and therefore no address conversion and protocol conversion are required.

If the address determination unit 74 determines that the IP address input to the first address receiver 73 is not available in the IPv6 network where the UAC 6 is located, that is, that the IP address input to the first address receiver 73 is an IPv4 address, the second address request unit 76 requests from the NAT-PT 9 an IP address of the UAC 6 available in the network where the UAS 10 is located. In this case, the request indicates that the network where the UAS 10 is located is an IPv4 network and the second address request unit 76 requests an IPv4 address of the UAC 6 from the NAT-PT 9.

The second address receiver 77 receives an IP address from the NAT-PT 9 as a response to the request from the second address request unit 76. That is, the second address receiver 77 receives an IPv4 address from the NAT-PT 9. For example, the second address receiver 77 may receive an IPv4 address 111.222.10.20 from the NAT-PT 9.

The mapping table update unit 78 updates a mapping table so as to map the IPv6 address of the UAC 6 and the IPv4 address of the UAC 6. That is, the mapping table update unit 78 adds a mapping entry to the mapping table for mapping the IPv6 address of the UAC 6 and the IPv4 address of the UAC 6 to each other, thereby updating the mapping table. For example, the mapping table update unit 78 may add a mapping entry to the mapping table for mapping an IPv6 address 3FFE:2E01::1 and an IPv4 address 111.222.10.20 to each other.

The address/protocol converter 79 converts an IPv6 address to an IPv4 address with reference to the mapping table updated by the mapping table update unit 78, and converts an IPv6 packet to an IPv4 packet using the converted IPv4 address. That is, the address/protocol converter 79 converts an IPv6 address recorded in a source address field of an IPv6 header to an IPv4 address with reference to the mapping table, removes a network prefix from an IPv6 address recorded in a destination address field of the IPv6 header, thereby converting the IPv6 packet to the IPv4 packet. For example, the address/protocol converter 79 may convert an address 3FFE:2E01::1 recorded in the source address field of the IPv6 header to an address 111.222.10.20 with reference to the mapping table, and remove a network prefix 3FFE:2E01:2A:4::/96 from an address 3FFE:2E01:2A:4:123.456.78.90 recorded in the destination address field of the IPv6 header, thereby converting the IPV6 packet to the IPv4 packet.

Also, the address/protocol converter 79 converts an IPv4 address to an IPv6 address with reference to the mapping table updated by the mapping table update unit 78 and converts an IPv4 packet to an IPv6 packet using the converted IPv6 address. That is, the address/protocol converter 79 converts an IPv4 address recorded in the source address field of the IPv4 header to an IPv6 address with reference to the mapping table, adds a network prefix to an IPv4 address recorded in the destination address field of the IPv4 header, thereby converting the IPv4 packet to the IPv6 packet. For example, the address/protocol converter 79 may convert an address 111.222.10.20 recorded in the source address field of the IPv4 header to an address 3FFE:2E01::1 with reference to the mapping table, and add a network prefix 3FFE:2E01:2A:4::/96 to an address 123.456.78.90 recorded in the destination address field the IPv4 header, thereby converting the IPv6 packet to the IPv4 packet.

The IPv6 packet may be an invitation message in an IPv6 format used when SIP signaling, a 200 OK message, an ACK message and an IPv6 packet used for RTP communication, and the IPv4 packet may be an invitation message in an IPv4 format used when SIP signaling, a 200 OK message, an ACK message and an IPv4 packet used for RTP communication.

The invitation message transmitter 75 transfers an invitation message converted by the address/protocol converter 79 to the UAS 10. The invitation message converted by the address/protocol converter 79 is a message in an IPv6 format. For example, a source address of the invitation message may be 111.222.10.20 and a destination address thereof may be 123.456.78.90.

The 200 OK message receiver 711 receives a 200 OK message from a UAS 10 that received the invitation message transferred from the invitation message transmitter 75, and outputs the received 200 OK message to the address/protocol converter 79. For example, a source address of the 200 OK message may be 123.456.78.90 and a destination address thereof may be 111.222.10.20.

The 200 OK message transmitter 712 transfers the 200 OK message converted by the address/protocol converter 79 to the UAC 6. The 200 OK message converted by the address/protocol converter 79 is a message in the IPv6 format. For example, the source address of the 200 OK message may be 3FFE:2E01:2A:4:123.456.78.90 and the destination address thereof may be 3FFE:2E01::1.

The ACK message receiver 713 receives an ACK message from a UAC 6 that received the 200 OK message transferred from the 200 OK message transmitter 712, and outputs the received ACK message to the address/protocol converter 79. The ACK message input to the ACK message receiver 713 is a message in the IPv6 format. For example, a source address of the ACK message may be 3FFE:2E01::1 and a destination address thereof may be 3FFE:2E01:2A:4:123.456.78.90.

The ACK message transmitter 714 transfers the ACK message converted by the address/protocol converter 79 to the UAS 10. The 200 OK message converted by the address/protocol converter 79 is a message in the IPv4 format. For example, a source address of the ACK message may be 111.222.10.20 and a destination address thereof may be 123.456.78.90.

The communication relay unit 715 relays RTP communication between the UAC 6 and the UAS 10 that received the ACK message from the ACK message transmitter 714, and returns an IPv4 address allocated to the UAC 6 to the NAT-PT 9 after the RTP communication is terminated. That is, the communication relay unit 715 transfers an IPv6 packet received from the UAC 6 as a format of an IPv4 packet to the UAS 10 in connection with the address/protocol converter 79, and transfers an IPv6 packet received from the UAS 10 as a format of an IPv4 packet to the UAC 6, thereby relaying the RTP communication.

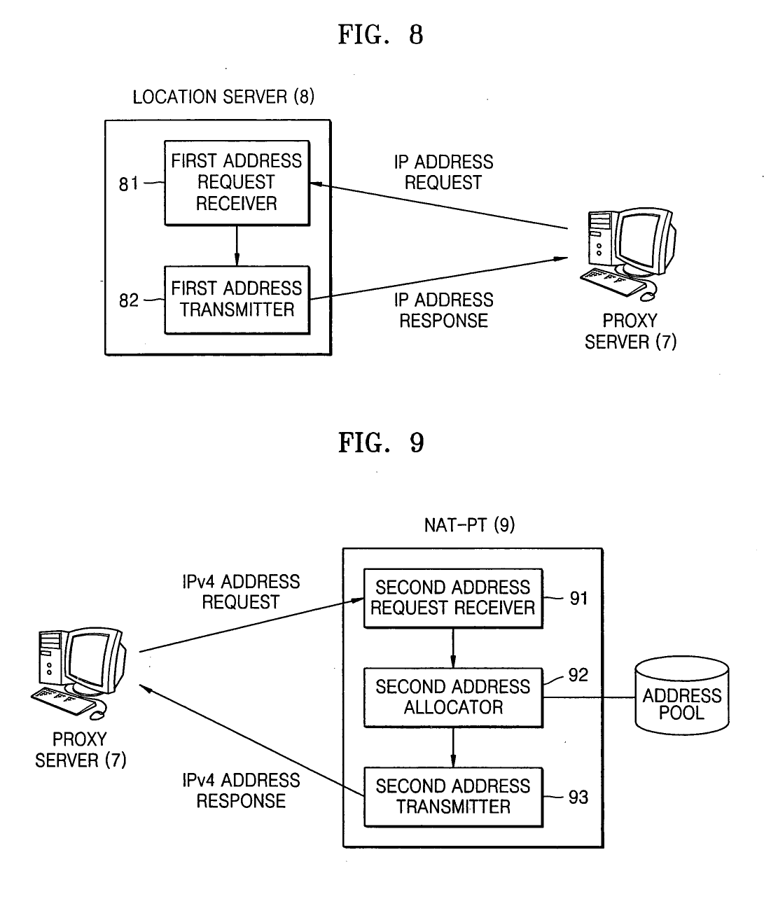

FIG. 8 is a schematic representation of a detailed configuration of the location server 8 in the communication system shown in FIGS. 4 and 5. Referring to FIG. 8, a location server 8 in the communication system shown in FIGS. 4 and 5 comprises a first address request receiver 81 and a first address transmitter 82.

The first address request receiver 81 receives a request for an IP address of a UAS 10 corresponding to a URI included in an invitation message from a proxy server 7. If the UAS 10 is located in the IPv6 network, the first address transmitter 82 transmits an IPv6 address, and if the UAS 10 is located in the IPv4 network, the first address transmitter 82 transmits an IPv4 address.

FIG. 9 is a schematic representation of a detailed configuration of the NAP-PT in the communication system shown in FIGS. 4 and 5. Referring to FIG. 9, a NAT-PT 9 in the communication system shown in FIGS. 4 and 5 comprises a second address request receiver 91, a second address allocator 92 and a second address transmitter 93. The second address request receiver 91 receives a request for an IPv4 address of the UAC 6 available in the IPv4 network where the UAS 10 is located.

The second address allocator 92 allocates one among IPv4 addresses stored in an address pool in response to the request input to the second address request receiver 91. For example, the second address allocator 92 may allocate an address 111.222.10.20 in response to the request input to the second address request receiver 91. The second address transmitter 93 transmits the IPv4 address allocated by the second address allocator 92 to the proxy server 7.

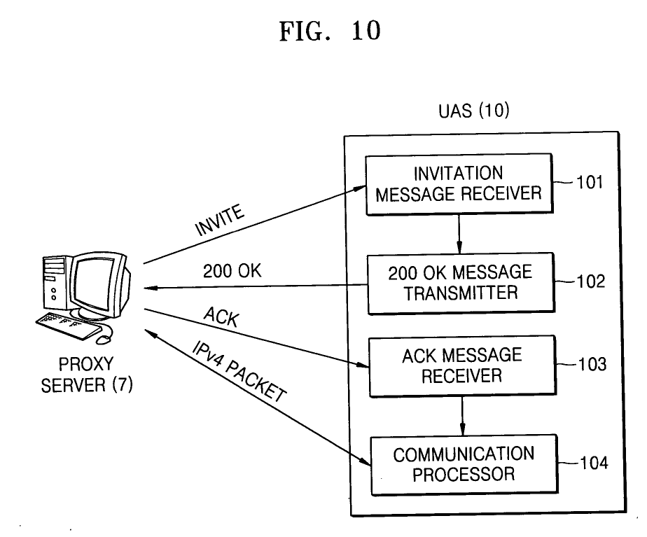

FIG. 10 is a schematic representation of a detailed configuration of the UAS in the communication system shown in FIGS. 4 and 5. Referring to FIG. 10, a UAS 10 in the communication system shown in FIGS. 4 and 5 comprises an invitation message receiver 101, a 200 OK message transmitter 102, an ACK message receiver 103 and a communication processor 104.

The invitation message receiver 101 receives an invitation message from a proxy server 7. The invitation message input to the invitation message receiver 101 is a message in the IPv4 format. For example, a source address of the invitation message may be 111.222.10.20 and a destination address thereof may be 123.456.78.90.

The 200 OK message transmitter 102 transmits a 200 OK message for the invitation message input to the invitation message receiver 101 to the proxy server 7. The 200 OK message transmitted from the 200 OK message transmitter 102 is a message in the IPv4 format. For example, a source address of the 200 OK message may be 123.456.78.90 and a destination address thereof may be 111.222.10.20.

The ACK message receiver 103 receives an ACK message from the proxy server 7 in response to the 200 OK message transmitted from the 200 OK message transmitter 103. The ACK message input to the ACK message receiver 103 is a message in the IPv4 format. For example, a source address of the ACK message is 111.222.10.20 and a destination address thereof may be 123.456.78.90.

If the ACK message receiver 103 receives the ACK message, the communication processor 104 performs RTP communication with a UAC 6 that received the ACK message via the proxy server 7. The packet which is input or output to/from the communication processor 64 is an IPv4 packet. For example, a source address of a packet output from the communication processor 104 may be 123.456.78.90 and a destination address thereof may be 111.222.10.20, and a source address of a packet input to the communication processor 104 may be 111.222.10.20 and a destination address thereof may be 123.456.78.90.

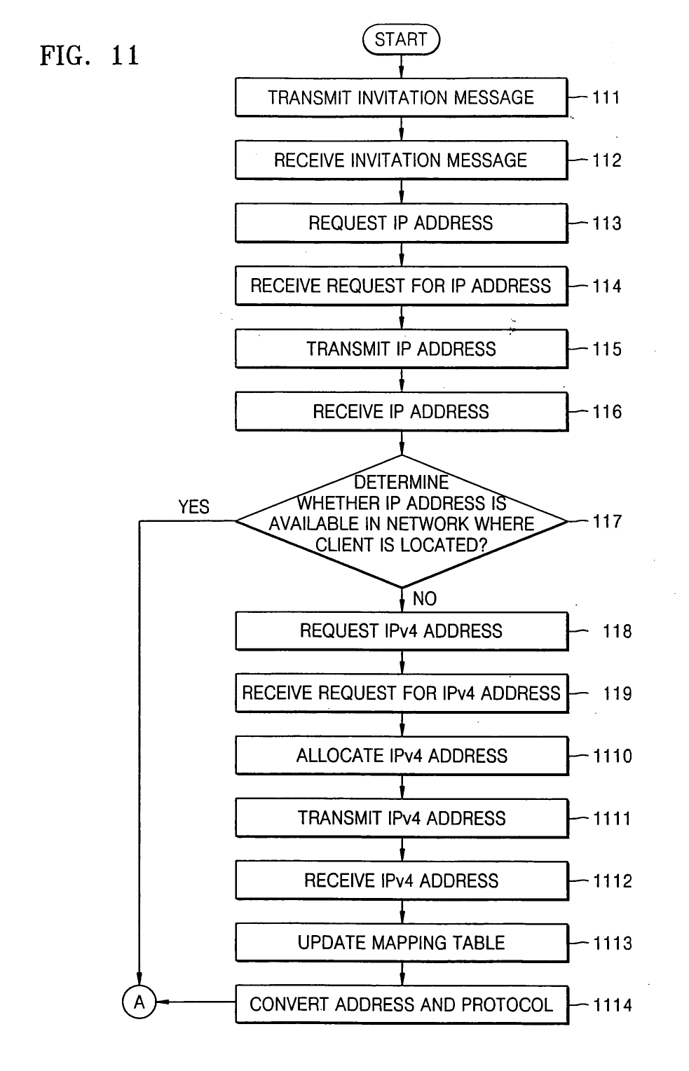

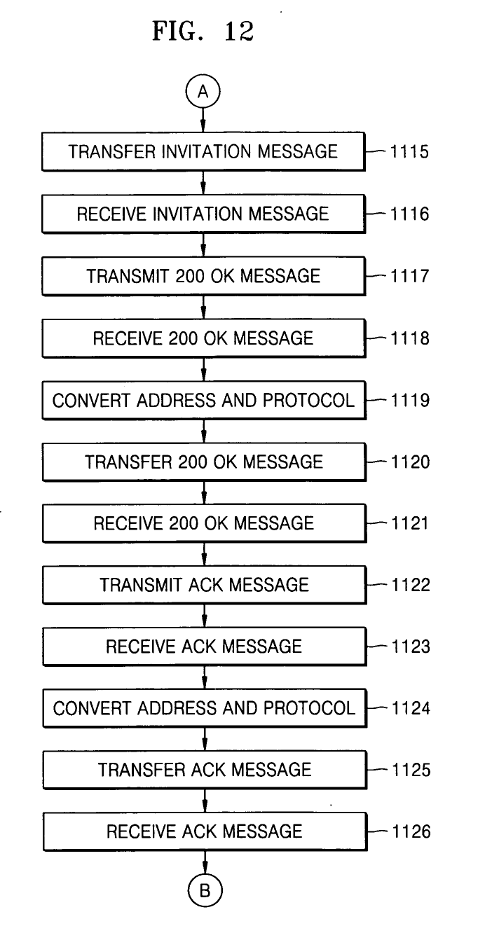

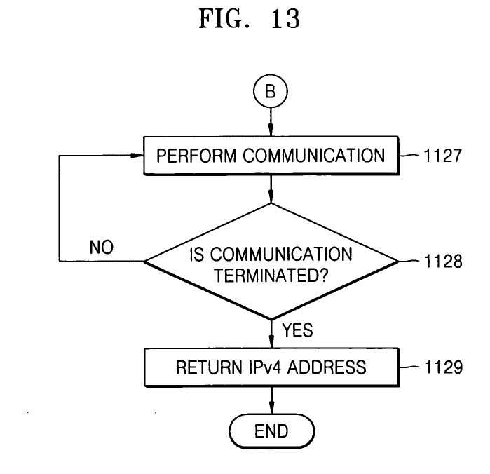

FIGS. 11, 12 and 13 are a flowchart illustrating a communication method according to an embodiment of the present invention. Referring to FIGS. 11, 12 and 13, the communication method comprises the following operations. The communication method includes operations that are sequentially processed by the communication system shown in FIGS. 4 and 5. Accordingly, detailed descriptions for the communication system shown in FIGS. 4 and 5 are omitted.

In operation 111, a UAC 6 transmits an invitation message including a URI of a UAS 10 to a proxy server 7 to start SIP signaling. In operation 112, the proxy server 7 receives the invitation message from the UAC 6. In operation 113, the proxy server 7 requests an IP address of a UAS 10 corresponding to a URI included in the invitation message received in operation 112 to the location server 8. In operation 114, the location server 8 receives the request for the IP address of the UAS 10 corresponding to the URI included in the invitation message transmitted from the proxy server 7. In operation 115, the location server 8 transmits an IPv6 address if the UAS 10 is located in the IPv6 network and transmits an IPv4 address if the UAS 10 is located in the IPv4 network. In operation 116, the proxy server 7 receives the IP address of the UAS 10 from the location server 8 in response to the request transmitted in operation 113.

In operation 117, the proxy server 7 determines whether the IP address received in operation 116 is available in the IPv6 network where the UAC 6 is located.

In operation 118, if it is determined in operation 117 that the IP address received in operation 116 is not available in the IPv6 network where the UAC 6 is located, that is, that the IP address received in operation 116 is an IPv4 address, the proxy server 7 requests, from a NAT-PT 9, an IPv4 address of the UAC 6 available in the network where the UAS 10 is located. In operation 119, the NAT-PT 9 receives the request for the IPv4 address of the UAC 6 available in the IPv4 network where the UAS 10 is located.

In operation 1110, the NAT-PT 9 allocates an IPv4 address among IPv4 addresses stored in an address pool in response to the request received in operation 119. In operation 1111, the NAT-PT 9 transmits the IPv4 address allocated in operation 1110 to the proxy server 7. In operation 1112, the proxy server 7 receives the IP address from the NAT-PT 9 as a response to the request transmitted in operation 118. In operation 1113, the proxy server 7 updates a mapping table to map an IPv6 address of the UAC 6 and an IPv4 address of the UAC 6 to each other. That is, in operation 1113, the proxy server 7 adds a mapping entry for mapping the IPv6 address of the UAC 6 and the IPv4 address of the UAC 6 to each other to the mapping table, thereby updating the mapping table. In operation 1114, the proxy server 7 converts the IPv6 address to an IPv4 address with reference to the mapping table updated in operation 1113 and converts the invitation message of the IPv6 format received in operation 1112 to an invitation message of the IPv4 format using the converted IPv4 address.

In operation 1115, if it is determined in operation 117 that the IP address received in operation 116 is available in the IPv6 network where the UAC 6 is located, that is, that the IP address received in operation 116 is an IPv6 address, the proxy server 7 transfers an invitation message whose destination address is the IPv6 address to the UAS 10 or transfers the invitation message converted in operation 1114 to the UAS 10. In operation 1116, the UAS 10 receives an invitation message from the proxy server 2. In operation 1117, the UAS 10 transmits a 200 OK message for the invitation message received in operation 1116 to the proxy server 7. In operation 1118, the proxy server 7 receives the 200 OK message from the UAS 10 that received the invitation message transmitted in operation 1115.

In operation 1119, the proxy server 7 converts an IPv4 address to an IPv6 address with reference to the mapping table updated in operation 1113 and converts the 200 OK message of the IPv4 format received in operation 1118 to a 200 OK message of the IPv6 format using the converted IPv6 address. In operation 1120, the proxy server 7 transfers the 200 OK message converted in operation 1119 to the UAC 6. In operation 1121, the UAC 6 receives the 200 OK message for the invitation message transmitted in operation 111 from the proxy server 7.

In operation 1122, the UAC 6 transmits an ACK message for the 200 OK message received in operation 1121 to the proxy server 7. In operation 1123, the proxy server 7 receives an ACK message from a UAC 6 that received the 200 OK message transmitted in operation 1120. In operation 1124, the proxy server 7 converts an IPv6 address to an IPv4 address with reference to the mapping table updated in operation 1113 and converts an ACK message of the IPv6 format received in operation 1123 to an ACK message of the IPv4 format using the converted IPv4 address. In operation 1125, the proxy server 7 transfers the ACK message converted in operation 1124 to the UAS 10. In operation 1126, the UAS 10 receives the ACK message for the 200 OK message transmitted in operation 1117 from the proxy server 7. In operation 1127, the UAC 6 and the UAS 10 perform RT communication via the proxy server 7.

In operation 1128, the proxy server 7 determines whether the RTP communication is terminated. In operation 1129, if the proxy server 7 determines that the RTP communication is terminated, the proxy server 7 returns the IPv4 address allocated to the UAC 6 to the NAT-PT 9.

Additionally, the embodiments of the present invention can also be embodied as computer readable code on a computer readable recording medium. The computer readable recording medium may be any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves.

As described above, according to the various embodiments of the present invention, it is possible to reduce the loads of the NAT-PT since the proxy server shares address conversion and protocol conversion functions with the NAT-PT. Accordingly, by removing delays of address conversion and protocol conversion in the NAT-PT, it is possible to enhance the speed of SIP signaling and RTP communication and improve the performance of packet routing over an entire network.

In particular, since the proxy server is based on the SIP, the proxy sever does not require a separate SIP-ALG. Therefore, it is possible to simplify the design of communication systems, to enhance the speed of SIP signaling and RTP communication and to improve the performance of packet routing over the entire network.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A communication relay method, comprising:
updating a mapping table so as to map a first address available in a network where a client is located and a second address available in a network where a server is located; and
relaying communication according to a protocol managing sessions between the client and the server on the basis of the updated mapping table.

2. The method of claim 1, wherein the protocol is a SIP (Session Initiation Protocol).

3. The method of claim 2, wherein the relaying comprises transmitting an invitation message, a 200 OK message and an ACK message from the client to the server according to the SIP.

4. The method of claim 1, wherein the relaying comprises transmitting a second packet whose source address is the second address to the server if a first packet whose source address is the first address is received.

5. The method of claim 1, further comprising:
basing a format of the first address on a first protocol and basing a format of the second address on a second protocol, and
converting the first address to the second address with reference to the mapping table and converting a packet based on the first protocol to a packet based on the second protocol using the converted second address.

6. The method of claim 5, wherein the first protocol is an IPv4 (Internet Protocol version 4) and the second protocol is an IPv6 (Internet Protocol version 6).

7. A proxy server, comprising:
a mapping table update unit updating a mapping table to map a first address available in a network where a client is located and a second address available in a network where a server is located; and
a communication relay unit relaying communication according to a protocol managing sessions between the client and the server on the basis of the mapping table updated by the mapping table update unit.

8. The proxy server of claim 7, wherein the protocol is a SIP (Session Initiation Protocol).

9. The proxy server of claim 7, wherein a format of the first address is based on a first protocol and a format of the second address is based on a second protocol, further comprising:
an address/protocol converting unit converting the first address to the second address with reference to the mapping table and converting a packet based on the first protocol to a packet based on the second protocol using the converted second address.

10. A computer storage for controlling a computer according to a method, the method comprising:
updating a mapping table to map a first address available in a network where a client is located and a second address available in a network where a server is located; and
relaying communication according to a protocol managing sessions between the client and the server on the basis of the updated mapping table.

11. A communication method, comprising:
providing an address available in a network where a server is located; and
relaying communication according to a protocol managing sessions between a client and the server using an address available in a network where the client is located and the provided address available in the network where the server is located.

12. The method of claim 11, wherein the protocol is a SIP (Session Initiation Protocol).

13. The method of claim 11, further comprising basing a format of the address available in the network where the client is located on a first protocol and basing a format of the address available in the network where the server is located on a second protocol.

14. The method of claim 13, wherein the relaying comprises converting the address available in the network where the client is located is to the address available in the network where the server is located, and converting a packet based on the first protocol to a packet based on the second protocol using the converted address.

15. The method of claim 13, wherein the first protocol is an IPv4 (Internet Protocol version 4) and the second protocol is an IPv6 (Internet Protocol version 6).

16. A communication system, comprising:
a router providing an address available in a network where a server is located; and
a proxy server relaying communication according to a protocol managing sessions between a client and the server using an address available in a network where the client is located and the address provided by the router.

17. The communication system of claim 16, wherein the protocol is a SIP (Session Initiation Protocol).

18. A computer storage for controlling a computer according to a method, the method comprising:
providing an address available in a network where a server is located; and
relaying communication according to a protocol managing sessions between a client and the server using an address available in a network where the client is located and the provided address in the network where the server is located.
